(19) United States
(12) Patent Application Publication
(10) Pub. No.: US 2004/0219455 A1
(43) Pub. Date: Nov. 4, 2004

(54) Ultra high-density recordable optical data recording media

(76) Inventors: Mei-Rurng Tseng, Hsinchu (TW); Wei-Chih Hsu, Hsinchu (TW); Song-Yeu Tsai, Hsinchu (TW); Min-Jen Deng, Hsinchu (TW)

Correspondence Address: BIRCH STEWART KOLASCH & BIRCH, PO BOX 747, FALLS CHURCH, VA, 22040-0747, US

(21) Appl. No.: 10/654,478

(22) Filed: Sep. 4, 2003

(30) Foreign Application Priority Data
May 2, 2003 (TW) 92112133

(51) Int. Cl. G11B 7/24

(52) U.S. Cl. 430/270.11; 430/945; 428/64.1; 369/284

(57) ABSTRACT

An ultra high-density recordable optical data recording media that which adds a near-field electromagnetic field enhancement layer between a substrate and a recording layer, by using the resonance enhancement effect produced between the near-field electromagnetic field enhancement layer and the recording layer to read very small recording marks (less than 100 nm) and increase the carrier to noise ratio and the recording density of the disks.

### BACKGROUND OF THE INVENTION

1. Field of Invention

The invention relates to an ultra high-density recordable optical data recording media and applies to the optical recording media.

2. Related Art

As the era of data and multimedia has arrived, the need to increase storage density and capacity has risen dramatically for the consumers of 3Cs (computers, communication, and consumer electronics). The currently accepted and widely used optical recording media is the compact disk (CD), the joint venture regulated by the red book published by the Dutch company Philips and the Japanese company Sony in 1982.

As the applications for multimedia increase, the requirements of image and sound quality from consumers are emphasized, and the demand for ultra high storage density and storage capacity also increase.

As the recording density increases, the recording marks have to become smaller to achieve high-density storage. However, for optical recording media, the light spots are limited by light's diffraction and cannot decrease the recording mark infinitely, due to the fact that reading devices cannot detect recording marks less than half the size of a light spot. Therefore, the improvement of the optical recording density is limited.

In theory, for optical recording systems, the laser light spots can only be reduced to about 0.62λ/NA, due to the optical diffraction limitation; where λ is the wavelength of the laser and NA is the numerical aperture of the focusing lens. It is concluded from the formula that if a smaller size laser light spot is needed in the optical recording system, a laser with shorter wavelength or a focusing lens with higher NA is required to reduce the laser light spot and effectively increase the recording density of the optical storage media.

However, short wavelength lasers with power over 30 mW and life cycle over 10,000 hours are expensive and difficult to obtain. Moreover, due to the limitation of technical bottlenecks, it is difficult to increase the NA value of the focusing lens. The focusing lens with a high NA value also requires the corresponding disk and the disk drive to possess higher optical and mechanical qualities. Therefore, the traditional optical recording media is limited by the NA value of the focusing lens and the laser beam wavelength, and the recording marks cannot be further reduced.

To overcome the bottleneck of optical diffraction limitations, technologies such as Super-RENS (super-resolution near-field structure) are applied to optical recording media. The characteristics and structures of the masking layer and recording layers decide the signal strength of the disk.

To solve the optical diffraction limitation problem, the optical recording media disclosed by U.S. Pat. No. 6,226,258 uses antimony (Sb) and its alloy as the masking layer material. When this material is exposed to laser beams, the optical characteristics change and form tiny holes for reading small recording marks.

The optical recording media disclosed by U.S. Pat. No. 20020067690 uses silver oxide (AgOₓ), antimony oxide (SbOₓ) and terbium oxide (TbOₓ) as the materials for the masking layer. It also takes advantage of the change of optical characteristics when the material is exposed to laser beams and allows the reading of small recording marks.

The described patents all use specified metal in the masking layer, such as antimony or silver and their alloy or oxides, and depend on the change of optical characteristics to achieve the reading of small recording marks. However, these materials do not have stable characteristics, so the optical recording media cannot perform very well with stability after long term usage.

### SUMMARY OF THE INVENTION

To alleviate the problems of the current technology, the invention provides an ultra high-density recordable optical data recording media. When the ultra high-density recordable optical data recording media is exposed to laser light, due to the enhanced resonance effect of the near-field electromagnetic field between the near-field electromagnetic wave enhancement layer and the recording layer, it is able to read the small recording marks in the recording layer (less than 100 nm) and increase the carrier to noise ratio (CNR) of the disk and its recording density.

The near-field electromagnetic wave enhancement layer uses materials which are dielectric materials with additional nano metal particles, such as adding gold (Au) to silica (SiO₂), or adding silver (Ag) to silica (SiO₂), or adding platinum (Pt) into silica (SiO₂). The compound forms nano-structure material with very stable characteristics and does not require to change the wavelengths of the laser beams or the NA value of the focus lenses. It can increase the recording density of the optical recording media and can be integrated easily with the current CD and DVD systems, which allows for immediate production.

The invention is an ultra high-density recordable optical recording media with the following structure: substrate, lower dielectric layer, near-field electromagnetic wave enhancement layer, interfacing layer, recording layer, upper dielectric layer, and protecting layer.

The lower dielectric layer, interfacing layer and upper dielectric layer all prepared with sputtering to use dielectric materials, such as silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), or a mixture of these compounds.

Therefore a near-field electromagnetic wave enhancement layer is formed on the surface of the lower dielectric layer by adding nano-structure composite materials with additional metal particles. By controlling the sputtering powers for both dielectric material and metal targets with co-sputtering method, the ratio of the dielectric materials and metal particles in the near-field electromagnetic wave enhancement layer, the diameters of the metal particles, and the distances between the metal particles can be adjusted and the different resonance enhancement effects can be achieved with various wavelengths of the laser beams.

Further scope of applicability of the invention will become apparent from the detailed description given hereinafter. However, it should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a structural diagram of the ultra high-density recordable optical data recording media;

FIG. 2 is an overview diagram of the near-field electromagnetic wave enhancement layer;

FIG. 3 is an overview picture shot by transmission electron microscopy (TEM), the near-field electromagnetic wave enhancement layer (the material of the dielectric material 31 is silica, and the material of the metal particle 32 is silver);

FIG. 4 is an overview picture shot by transmission electron microscopy (TEM), the near-field electromagnetic wave enhancement layer (the material of the dielectric material 31 is silica and the material of the metal particle is gold)

FIG. 5 is the relationship curves between carrier to noise ratio and recording mark size with different near-field electromagnetic wave enhancement layers;

FIG. 6 is a structural diagram of the second embodiment of the invention;

FIG. 7 is a structural diagram of the third embodiment of the invention;

FIG. 8 is a structural diagram of the forth embodiment of the invention;

FIG. 9 is a structural diagram of the fifth embodiment of the invention;

FIG. 10 is a structural diagram of the sixth embodiment of the invention;

FIG. 11 is a structural diagram of the seventh embodiment of the invention;

FIG. 12 is a structural diagram of the eighth embodiment of the invention;

FIG. 13 is a structural diagram of the ninth embodiment of the invention; and

FIG. 14 is the relationship curves between the carrier to noise ratio and recording mark size of the high-density recordable optical data recording media produced by the method revealed from the second, third, fourth, fifth, seventh, eighth, and ninth embodiments.

### DETAILED DESCRIPTION OF THE INVENTION

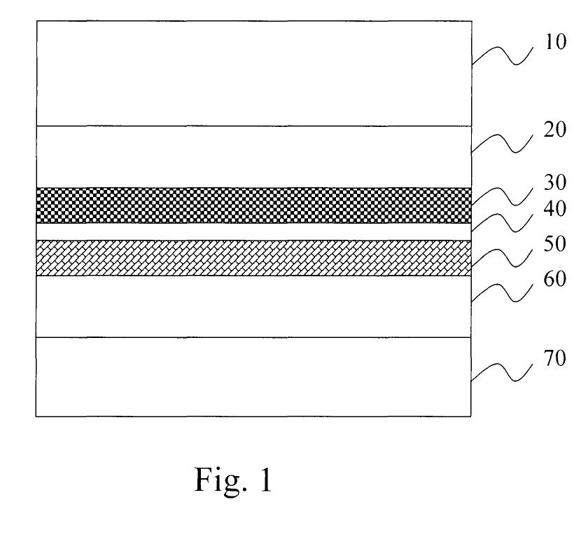

The invention discloses an ultra high-density recordable optical data recording media. The structural side view of the first embodiment is illustrated in FIG. 1 and includes seven layers: the substrate 10, lower dielectric layer 20, near-field electromagnetic wave enhancement layer 30, interfacing layer 40, recording layer 50, upper dielectric layer 60, and protecting layer 70.

The substrate 10 is a transparent substrate, capable of supporting the recordable media for ultra high-density optical data recording. The material of the substrate is polycarbonate.

The lower dielectric layer 20 covers the surface area of the substrate 10. The material of the lower dielectric layer 20 with a thickness between 20 nm and 200 nm is chosen from the following materials: silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), or mixtures of any of these.

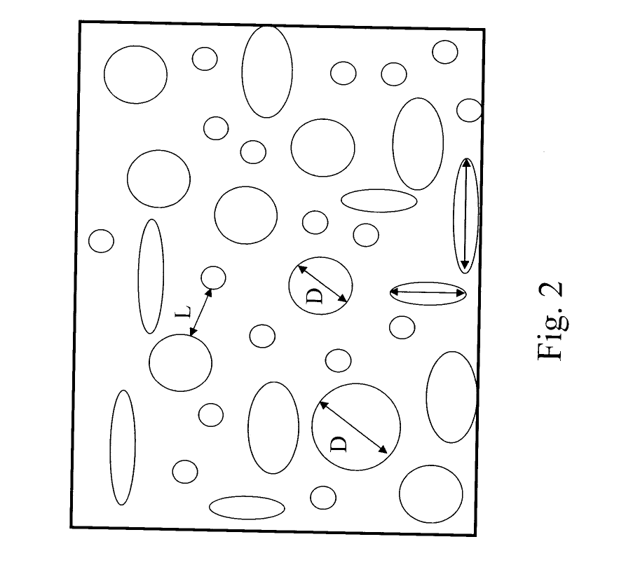

The near-field electromagnetic wave enhancement layer 30 covers the surface of the lower dielectric layer 20 and its overview diagram is illustrated by FIG. 2. The near-field electromagnetic wave enhancement layer 30 uses composite material by adding metal particles 32 into the dielectric materials 31. The dielectric materials 31 can be silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), or mixtures thereof.

The metal particles 32 can be gold (Au), silver (Ag), copper (Cu), aluminum (Al), platinum (Pt), palladium (Pd), chromium (Cr), tungsten (W), or the metal particles of the alloys of any of these metals. The diameter D of these metal particles 32 and the distance L between each particle 32 influences the strength of the resonance effect between the near-field electromagnetic wave enhancement layer and the recording layer 50. The near-field electromagnetic wave enhancement layer 30 has a thickness ranging from 1 nm to 80 nm.

The ultra high-density recordable optical data recording media can use a laser light source with different wavelengths to execute reading and writing of data. The laser light source can be: red laser light with wavelengths of 780, 650, or 635 nm, or blue laser light with a wavelength of 405 nm. Therefore, when using laser light sources of different wavelengths to execute reading and writing of the data, different sizes of metal particles 32 need to be used accordingly and the distances between the metal particles 32 also need to be adjusted to achieve the appropriate enhanced resonance effect. In the near-field electromagnetic wave enhancement layer 30, the dielectric material 31 and the metal particles 32 have the volume ratio between 1:0.01 and 1:100. The desired length of the diameter D for the metal particle 32 ranges between 0.5 nm and 100 nm. The desired distance L between each of the metal particles 32 ranges between 0.5 nm and 100 nm.

The interfacing layer 40 covers the top of the near-field electromagnetic wave enhancement layer 30 and uses the same dielectric material as the lower dielectric layer 20, such as: silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), or a mixture of any of these compounds. The range of thickness for the interface layer 40 is 1 nm to 80 nm.

The recording layer 50 covers the above interfacing layer 40 and the recording media is made from one of the following types of material: phase change material, magneto optical recording material, organic write once recording material, or inorganic write once recording material. The thickness of the recording layer 50 ranges from 2 nm to 120 nm.

The upper dielectric layer 60 covers the recording layer 60 and uses the same dielectric material as the lower dielectric layer 20 and interfacing layer 40, such as: silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), or a mixture of these compounds. The thickness of the upper dielectric layer 60 ranges from 20 nm to 200 nm.

Finally, the protecting layer 70 covers the upper dielectric layer 60, and its material is UV curing resin or other insulating material.

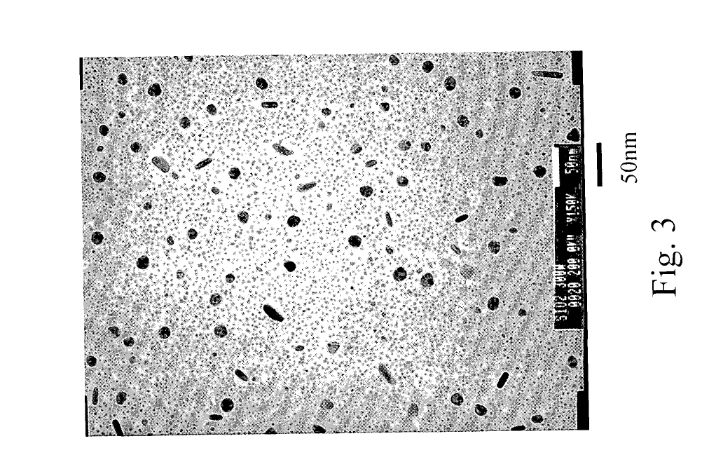

Please refer to FIG. 3, which illustrates the overview of the nano-structure formed by the dielectric material 31 in the near-field electromagnetic wave enhancement layer 30 and metal particles 32 that are photographed by transmission electron microscopy (TEM). The black portions of the picture are the metal particles 32 and the metal material used for these particles is silver (Ag). The gray and more transparent portions of the picture are the dielectric material 31, which is silica (SiO₂). From the scale of FIG. 3, it is possible to determine that the larger silver particles have diameters of approximately 14.3 nm, and the smaller silver particles have diameters of approximately 3 nm. The distance between each silver particle is about 2.84 nm.

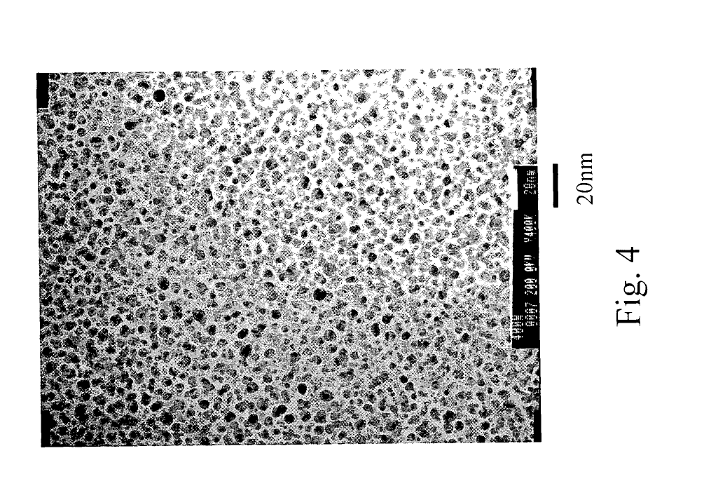

Please refer to FIG. 4 for the illustration of the overview of the nano-structure formed by the dielectric material 31 in the near-field electromagnetic wave enhancement layer 30 and metal particles 32 that are photographed by transmission electron microscopy (TEM). The black portions in the picture are the metal particles 32 and the metal material of the particles used is gold (Au). The gray and more transparent portions of the picture are the dielectric material 31 of silica (SiO₂). From the scale of FIG. 4, it is possible to determine that the gold particles have a diameter of approximately 3.5 nm and the distance between each gold particle is about 1.81 nm.

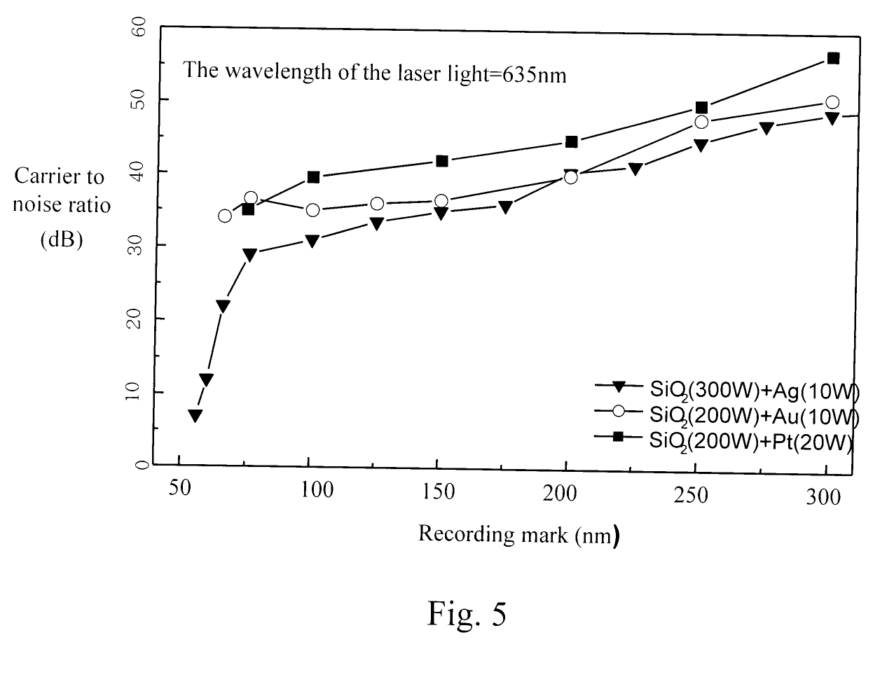

Please refer to FIG. 5 for the relationship curves of the carrier to noise ratio and the record mark size tested by using a laser light source with a wavelength of 635 nm on the first embodiment of the ultra high-density recordable optical data recording media on the structure of the different near-field electromagnetic wave enhancement layer 30.

The first curve uses silica (SiO₂) as the dielectric material 31 in the near-field electromagnetic wave enhancement layer 30, and silver (Ag) as the material of the metal particles 32. The larger metal particles 32 are 14.3 nm in diameter and the smaller metal particles 32 are 3 nm in diameter. The distances between the smaller metal particles 32 are about 2.84 nm. The second curve uses silica (SiO₂) as the dielectric material 31 in the near-field electromagnetic wave enhancement layer, and gold (Au) as the material of metal particles 32 with diameters of about 4.1 nm. The distances between the metal particles 32 are 1.99 nm. The third curve uses silica (SiO₂) as the dielectric material 31 in the near-field electromagnetic wave enhancement layer, and (Pt) as the material of metal particles 32 with diameters of about 2.0 nm. The distances between the metal particles 32 are approximately 1.0 nm.

Concluded from this relationship graph, in the ultra high-density recordable optical data recording media that is revealed in the first embodiment, even when the recording marks are reduced to 50-75 nm, the signals can still be recognized. Therefore, comparing with the traditional DVD, the recognizable range of the recording marks is reduced significantly and the recording density of the optical recording media is improved.

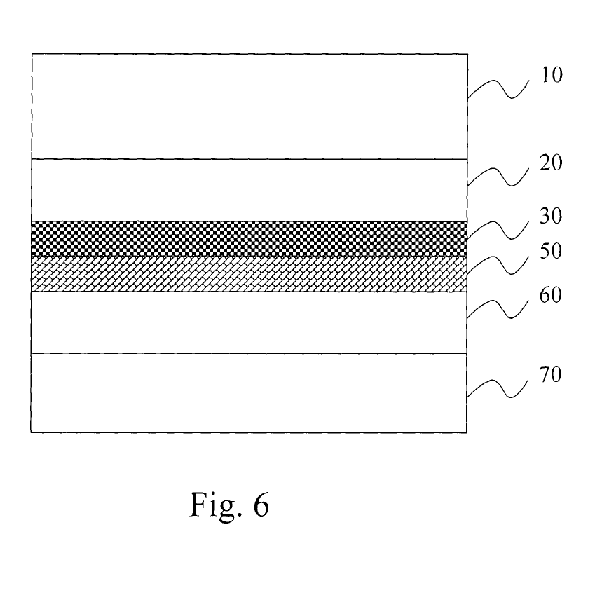

Please refer to FIG. 6 for a structural view of the second embodiment of the invention. The structure is similar to the first embodiment, except this embodiment does not have the interfacing layer 40 between the near-field electromagnetic wave enhancement layer 30 and the recording layer 50. The recording layer 50 is formed directly on the top of the near-field electromagnetic wave enhancement layer 30.

The structure of the ultra high-density recordable optical data recording media revealed by second embodiment also takes advantage of the enhanced resonance effect between the near-field electromagnetic wave enhancement layer 30 and the recording layer 50 to achieve reading of small recording marks (less than 100 nm). It improves the carrier to noise ratio (CNR) of the disk and raises the recording density of the disk.

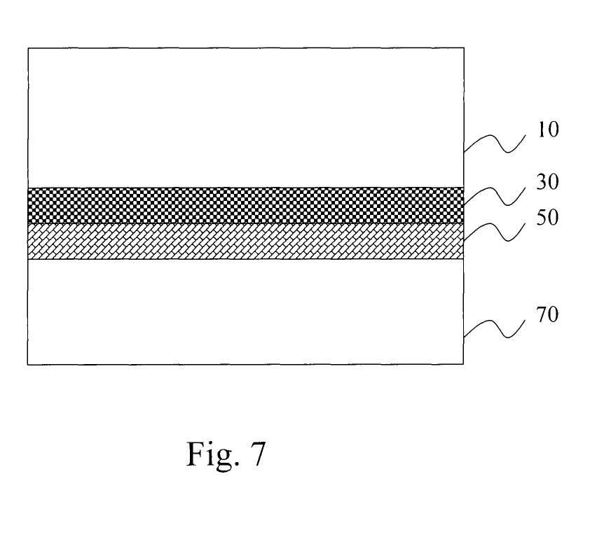

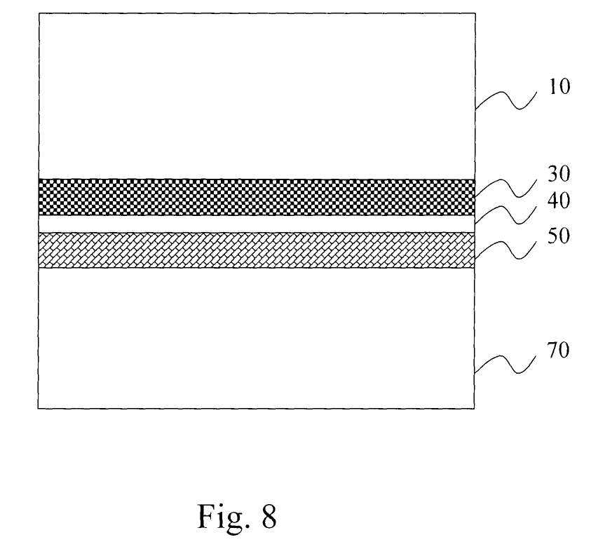

Next, please refer to FIG. 7 for a structural view of the third embodiment of the invention, which is similar to the second embodiment, but more concise structurally and omitting the lower dielectric layer 20 and upper dielectric layer 60 from the second embodiment. The structural view of the fourth embodiment is illustrated by FIG. 8, which is similar to the third embodiment, except that the fourth embodiment adds the interfacing layer 40 between the near-field electromagnetic wave enhancement field 30 and the recording layer 50.

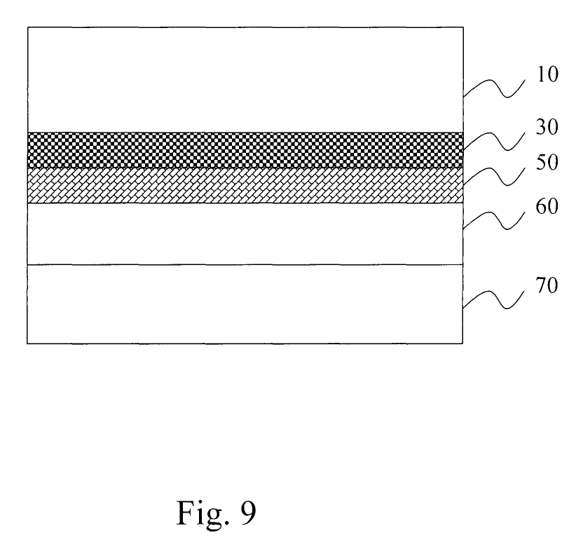

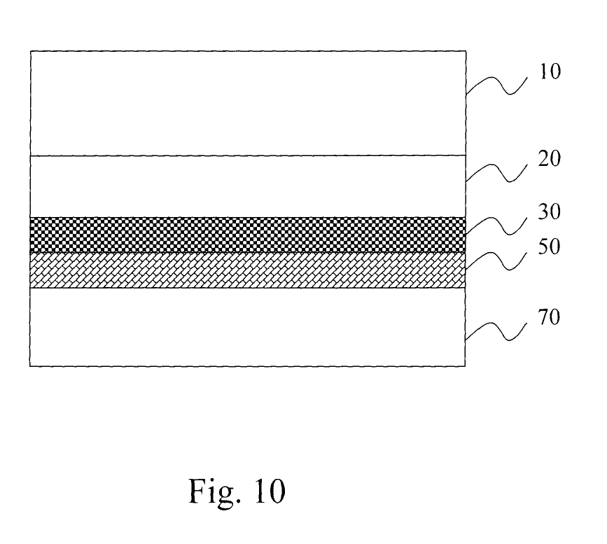

Please refer to FIG. 9 for a structural view of the fifth embodiment of the invention, which is similar to the third embodiment, except for the additional upper dielectric layer 60 between the recording layer 50 and the protection layer 70. The structural diagram of the sixth embodiment is illustrated by FIG. 10; it is similar to the third embodiment, except for adding a lower dielectric layer 20 between the near-field electromagnetic wave enhancement layer 30 and the substrate 10.

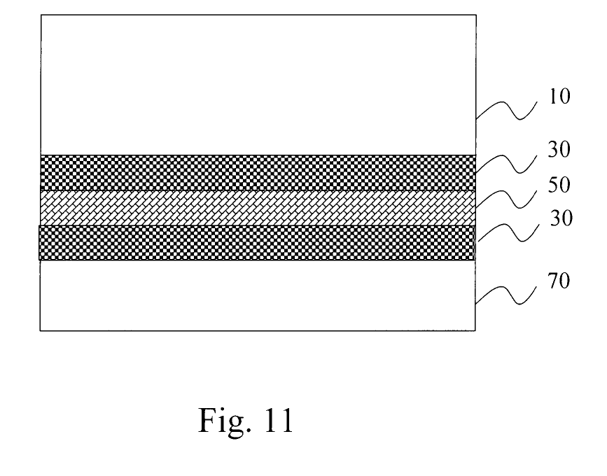

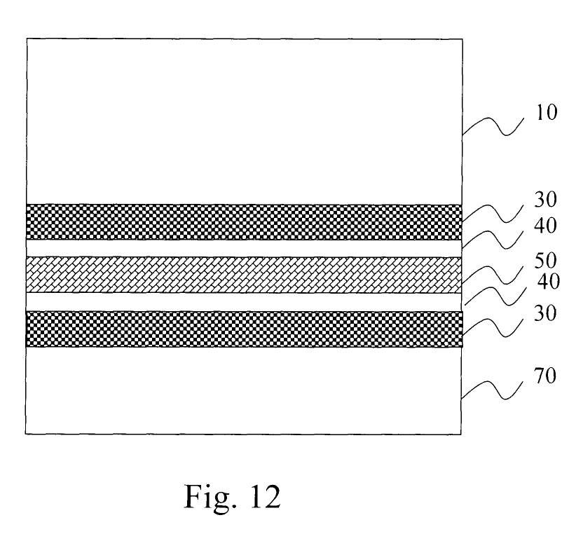

Please refer to FIG. 11 for a structural diagram of the seventh embodiment of the invention which is similar to the third embodiment, except for the additional near-field electromagnetic wave enhancement layer 30 between the recording layer 50 and the protecting layer 70. As shown in FIG. 12 the structural diagram of the eighth embodiment of the invention the structure is similar to the seventh embodiment except for the extra interfacing, layer 40 between the upper near-field electromagnetic wave enhancement layer 30 and the middle recording layer 50, and between the lower near-field electromagnetic wave enhancement layer 30 and the middle recording layer 50.

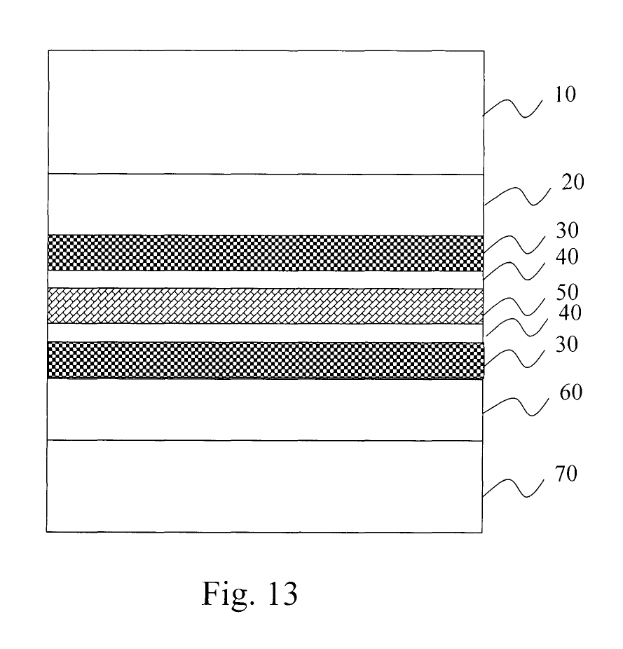

Finally, please refer to FIG. 13 for the structural diagram of the ninth embodiment of the invention which is similar to the eighth embodiment, except for the extra lower dielectric layer 20 between the lower near-field electromagnetic wave enhancement layer 30 and substrate 10, and the extra upper dielectric layer 60 between the upper near-field electromagnetic wave enhancement layer 30 and the protecting layer 70.

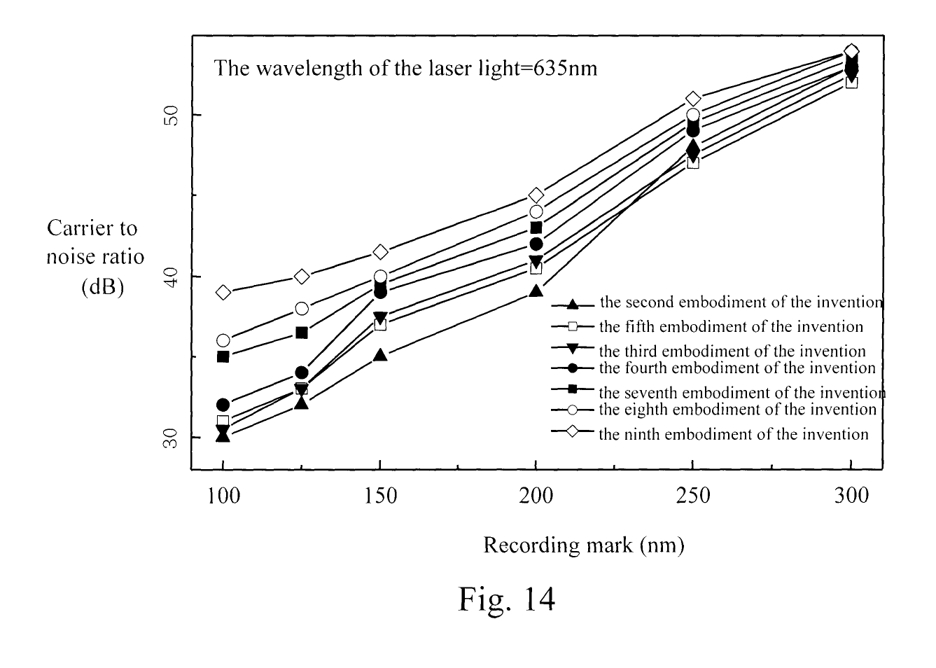

Please refer to FIG. 14, which illustrates the relationship curves of the carrier to noise ratio and recording mark size tested by the laser light source with a wavelength of 635 nm of the ultra high-density recordable optical data recording media produced by the production method revealed from the second, third, fourth, fifth, seventh, eighth, and ninth embodiments.

The curves in the relationship graph have a near-field electromagnetic wave enhancement layer 30 formed by the dielectric material 31 of silica (SiO₂), and the material of the metal particles material is gold (Au). It is concluded from the curves in the graph that the recording marks can still be recognized when reduced to 100 nm, which is much smaller than the recording marks of the traditional DVD. This greatly improves the recording density of the recording media.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An ultra high-density recordable optical data recording media, used to data storage, utilizing a laser light for reading and writing data, comprises of:
a substrate, made from a transparent material;
a near-field electromagnetic wave enhancement layer, made from a dielectric material with a plurality of metal particles, and covering the surface of the substrate;
a recording layer, covering the surface of the near-field electromagnetic wave enhancement layer to data storage, and the near-field electromagnetic field between the near-field electromagnetic wave enhancement layer and the recording layer resulted in a resonance enhancement effect; and
a protecting layer covering the surface of the recording layer.

2. The ultra high-density recordable optical recording media of claim 1, wherein the dielectric material is selected from the group consisting of silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), and combinations of them.

3. The ultra high-density recordable optical recording media of claim 1, wherein the material of the metal particles is selected from the group consisting of gold (Au), gold alloy, silver (Ag), silver alloy, copper (Cu), copper alloy, aluminum (Al), aluminum alloy, platinum (Pt), platinum alloy, palladium (Pd), palladium alloy, chromium (Cr), chromium alloy, tungsten (W), tungsten alloy, and combinations of them.

4. The ultra high-density recordable optical recording media of claim 1, wherein the size of the metal particles and distances between the metal particles can be adjusted according to the wavelength of the laser light to achieve the desired resonance effect.

5. The ultra high-denisity recordable optical recording media of claim 1, wherein the range of the volume ratio of the dielectric material and the metal particles in the near-field electromagnetic wave enhancement layer is from 1:0.01 to 1:100, and the thickness of the near-field electromagnetic wave enhancement layer being preferable between 1 nm to 80 nm.

6. The ultra high-density recordable optical recording media of claim 1, wherein the range of the diameters of the metal particles is from 0.5 nm to 100 nm.

7. The ultra high-density recordable optical recording media of claim 1, wherein the range of distances between the metal particles is from 0.5 nm to 100 nm.

8. The ultra high-density recordable optical recording media of claim 1 further comprising an interfacing layer between the near-field electromagnetic wave enhancement layer and the recording layer, and the thickness of the interfacing layer being preferable between 1 nm to 80 nm.

9. The ultra high-density recordable optical recording media of claim 8, wherein the material of the interfacing layer is selected from the group consisting of silica (SiO₂), titanium oxide (TiOₓ), tantalum oxide (TaOₓ), zinc sulfide (ZnS), silicon nitride (SiNₓ), aluminum nitride (AlNₓ), silicon carbide (SiC), silicon (Si), and combinations of them.

10. The ultra high-density recordable optical recording media of claim 1 further comprising an upper dielectric layer between the recording layer and the protecting layer, and the thickness of the upper dielectric layer being preferable between 20 nm to 200 nm.

11. The ultra high-density recordable optical recording media of claim 10, wherein the material of the upper dielectric layer is selected from the group consisting of silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), and combinations of them.

12. The ultra high-density recordable optical recording media of claim 1 further comprising a lower dielectric layer between the substrate and the near-field electromagnetic wave enhancement layer, and the thickness of the upper dielectric layer being preferable between 20 nm to 200 nm.

13. The ultra high-density recordable optical recording media of claim 12, wherein the material of the lower dielectric layer is selected from the group consisting of silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), and combinations of them.

14. The ultra high-density recordable optical recording media of claim 1 further comprising a lower dielectric layer between the substrate and the near-field electromagnetic wave enhancement layer and an upper dielectric layer between the recording layer and the protecting layer, the thickness of the lower dielectric layer being preferable between 20 nm to 200 nm, and the thickness of the upper dielectric layer being preferable between 20 nm to 200 nm.

15. The ultra high-density recordable optical recording media of claim 14, wherein the material of the lower and upper dielectric layer is selected from the group consisting of silica (SiO₂), titanium oxide (TiOₓ), tantalum oxide (TaOₓ), zinc sulfide (ZnS), silicon nitride (SiNₓ), aluminum nitride (AlNₓ), silicon carbide (SiC), silicon (Si), and combinations of them.

16. The ultra high-density recordable optical recording media of claim 14 further comprising an interfacing layer between the near-field electromagnetic wave enhancement layer and the recording layer, and the thickness of the interfacing layer being preferable between 1 nm to 80 nm.

17. The ultra high-density recordable optical recording media of claim 16, wherein the material of the interfacing layer is selected from the group consisting of silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), and combinations of them.

18. The ultra high-density recordable optical recording media of claim 1 full-the comprising another near-field electromagnetic wave enhancement layer between the recording layer and the protecting layer, and the thickness of the another near-field electromagnetic wave enhancement layer being preferable between 1 nm to 80 nm.

19. The ultra high-density recordable optical recording media of claim 18 further comprising an interfacing layer between the recording layer and the near-field electromagnetic wave enhancement layer, and another interfacing layer between the recording layer and the another near-field electromagnetic wave enhancement layer, the thickness of the interfacing layer being preferable between 1 nm to 80 nm, and the thickness of the another interfacing layer being preferable between 1 nm to 80 nm.

20. The ultra high-density recordable optical recording media of claim 19, wherein the material of the interfacing layer and the another interfacing layer is selected from the group consisting of silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), and combinations of them.

21. The ultra high-density recordable optical recording media of claim 19 further comprising a lower dielectric layer between the substrate and the near-field electromagnetic wave enhancement layer and an upper dielectric layer between the another near-field electromagnetic wave enhancement layer and the protecting layer, the thickness of the lower dielectric layer being preferable between 2 nm to 200 nm, and the thickness of the upper dielectric layer being preferable between 2 nm to 200 nm.

22. The ultra high-density recordable optical recording media of claim 21, wherein the material of the lower and upper dielectric layer is selected from the group consisting of silica (SiO₂), titanium oxide (TiO₂), tantalum oxide (TaOₓ), zinc sulfide (ZnS), silicon nitride (SiNₓ), aluminum nitride (AlNₓ), silicon carbide (SiC), silicon (Si), and combinations of them.
